(19) United States
(12) Patent Application Publication
(10) Pub. No.: US 2003/0177893 A1
(43) Pub. Date: Sep. 25, 2003

(54) Audio parameter managing method for application software, application software program thereof and audio reproduction apparatus thereof

(76) Inventor: Toshinobu Takeuchi, Sanda-shi (JP)

Correspondence Address: Kenneth C. Winterton, SHERIDAN ROSS P.C., 1560 Broadway, Suite 1200, Denver, CO, 80202-5141, US

(21) Appl. No.: 10/382,423

(22) Filed: Mar. 5, 2003

(30) Foreign Application Priority Data
Mar. 7, 2002 (JP) PAT. 2002-61440
Jan. 31, 2003 (JP) PAT. 2003-25321

(51) Int. Cl. G10H 1/02

(52) U.S. Cl. 84/626

(57) ABSTRACT

A method of managing audio parameter of application software according to the present invention is a method of managing audio parameter of application software used on the operating system, wherein at start of the application software, a starting audio parameter set in said operating system is stored, and whatever the starting audio parameter may be, audio data playback function is performed according to an exiting audio parameter when the application software was exited last time; and at exit of the application software, audio parameter at this time is stored as the exiting audio parameter of the application software and setting is switched from the exiting audio parameter to the starting audio parameter and audio data playback function is performed according to the starting audio parameter.

Audio parameter managing method for application software, application software program thereof and audio reproduction apparatus thereof

### BACKGROUND OF THE INVENTION

The present invention relates to an audio player, a method of managing an audio parameter of application software and program thereof.

Generally, application software for music record/playback and application software that manages audio files have a function of adjusting a control parameter (hereinafter referred to as “audio parameter”) for volume of output audio, mute-on/off, left-right output balance of a stereo and so on.

Traditionally, when application software for audio record and/or playback with an audio parameter managing function or application software that has an audio parameter managing function and manages audio data files are used on an operating system, sound is output according to a set of values of the audio parameter set in the operating system.

However, optimal value of the audio parameter often varies depending on application software. Users had to set the audio parameter to optimal value every time they switch application software.

Unexamined Paten Publications No. 2001-43062 and No. 2001-256041 disclose computers of conventional examples 1 and 2 in which when the user installs and uses application software, the user registers audio volume value and left-right output balance during operation of the application software for each application software. In the computers of the conventional examples 1 and 2, audio data is played in accordance with the registered audio parameter.

In the computers of the conventional examples, however, the user had to register value of the audio parameter for each application software.

In the personal computer of the conventional example 1 (Unexamined Paten Publication No. 2001-43062), an audio volume control coefficient is set for each application software and stored. When the user turns an audio volume control knob, the personal computer outputs sound as the value obtained by multiplying audio data by the audio volume control coefficient by the audio volume value of the audio volume control knob. The user registers the audio volume control coefficient for each application software in accordance with the volume control function displayed on a screen (S11 of FIG. 2).

In the personal computer of the conventional example 2 (Unexamined Paten Publication No. 2001-256041), when the user turns an audio volume control knob, the message that requires the user to determine whether or not a new audio volume value is registered is displayed on a screen. When the user gives an instruction of registration to the computer, the new audio volume value is registered (steps 170 to 182 of FIG. 5).

In general, the user feels the registering operation of audio parameter is troublesome. Unless the user registers the audio parameter, sound is output according to a common the same audio parameter to all application software, resulting in the user's dissatisfaction. There are many cases where the user wants to change the value of the audio parameter after registration. Personal computers of the conventional examples have a problem of imposing the user on an extra registering operation.

The object of the present invention is to provide an audio player, a method of managing an audio parameter of application software and program thereof that automatically register an appropriate value of the audio parameter set by the user for each application software without imposing the user on an extra registering operation.

With the personal computer of the conventional example 1, in the case that the audio volume control knob is set to be constant, the audio parameter of the operating system (audio volume value of the audio volume control knob) becomes constant. The application software multiplies audio data by the audio volume control coefficient at every sampling time of the audio data (for example, every about 20 μs in normal compact disc, and about 5 μs in DVD audio apparatus) and sends the calculated value to the operating system. The personal computer of the conventional example 1 had the problem of imposing a heavy burden of calculation on the application software. Arithmetic processing, especially in handheld device equipped with CPU with low power consumption and relatively low computing power, can slow down operation of the application software.

In the personal computer of the conventional example 2, the audio parameter of the operating system is replaced with that of the application software. This allows each application software to output sound in accordance with the optimal audio parameter. Operating systems in itself usually has an audio output function. In the conventional example 2, at exit of the application software, the operating system outputs sound in accordance with the value of audio parameter of the application software exited immediately before. Every time the application software is exited, parameter value of sound output by the operating system varies. The conventional example 2 has a problem that the operating system operates at the audio parameter value different from the optimal value.

The object of the present invention is to provide an audio player, a method of managing an audio parameter of application software and program thereof in which each of application software and operating system automatically operates at the appropriate audio parameter value without imposing a heavy burden of calculation on the application software.

The conventional examples 1 and 2 disclose that audio volume value of output sound and left-right output balance of a stereo are registered for each application software. However, as the audio parameter registered for each application software, these parameters were still insufficient. For example, when using a computer in office, many users use application software of a word professor in mute-on mode (quiet mode) during office hours and play application software of a computer game in mute-off mode (sound mode) during break time. In the conventional examples 1 and 2, the user had to change manually mute-on/off settings every time switching over one to another application software.

Moreover, typically there are both cases where the user needs or does not need to generate sound (mouse click sound, error-alarming sound, etc.) during operation of the operating system depending on the situation. For example, the user turns the sound off in mute-on mode during operation at quiet library or in the nighttime, and make a sound in mute-off mode during operation in the daytime. Under such situation, however, there is a case where the user wants to reverse the mute-on/off mode for certain application software. For example, even when the user uses the computer in mute-on mode in the nighttime, alarm clock program started by a timer needs to make a sound. Alternatively, even in the daytime, the user may need no sound other than mouse click sound and error-alarming sound, when he uses graphic software and wants to check only visual image.

The object of the present invention is to provide an audio player, a method of managing an audio parameter of application software and program thereof that automatically set the appropriate mute-on/off mode controlled by the user for each application software after each switching over to another application software.

The object of the present invention is to provide an audio player, a method of managing an audio parameter of application software and program thereof that set and manage the optimal audio parameter for audio playback of each of application software and operating system by starting audio parameter setting function a minimum number of times.

### SUMMARY OF THE INVENTION

To solve the above-mentioned problems, the present invention has the following constitution. A method of managing audio parameter of application software in accordance with the present invention from one aspect is a method of managing audio parameter of application software for audio record and/or playback with an audio parameter managing function or application software that has an audio parameter managing function and manages audio data files, which are used on an operating system, wherein

audio parameter comprises at least one parameter of audio volume value and mute-on/off information,

at start of the above-mentioned application software, a starting audio parameter set in the above-mentioned operating system is stored, and whatever the above-mentioned starting audio parameter may be, audio data playback function is performed according to an exiting audio parameter when the above-mentioned application software was exited last time,

at exit of the above-mentioned application software, audio parameter at this time is stored as the above-mentioned exiting audio parameter of the above-mentioned application software, setting is switched from the above-mentioned exiting audio parameter to the above-mentioned starting audio parameter set on the above-mentioned operating system before start of the above-mentioned application software, and audio data playback function is performed according to the above-mentioned starting audio parameter.

A program of a method of managing audio parameter of application software in accordance with the present invention from another aspect is a program of a method of managing audio parameter of application software for audio record and/or playback with an audio parameter managing function or application software that has an audio parameter managing function and manages audio data files, wherein the audio parameter comprises at least one parameter of audio volume value and mute-on/off information, and the device that operates on an operating system for loading and performing the program comprises

an operating audio parameter setting section that sets an operating audio parameter working with an audio parameter set on the above-mentioned operating system in response to the user's switch of setting of audio parameter during operation of the above-mentioned application software,

a starting audio parameter storage section that stores the audio parameter set on the above-mentioned operating system at start of the above-mentioned application software therein, and

an exiting audio parameter storage section that stores the above-mentioned operating audio parameter at that time of the above-mentioned application software at exit of the above-mentioned application software therein.

An audio player in accordance with the present invention from another aspect is an audio player with an operating system for installing program of a first application software as the above-mentioned application software and performing operations thereof, wherein

the above-mentioned operating system comprises an installation section for installing program of the above-mentioned first application software, and a output audio parameter setting section for setting audio parameter of audio playback output in response to change in audio parameter,

at start of the above-mentioned first application software, audio parameter set in the above-mentioned output audio parameter setting section is stored in the above-mentioned starting audio parameter storage section of the above-mentioned first application software, the audio parameter stored in the above-mentioned exiting audio parameter storage section of the above-mentioned first application software is read out, and the value is set in the above-mentioned operating audio parameter setting section,

during operation of the above-mentioned first application software, sound is played while the audio parameter stored in the above-mentioned operating audio parameter setting section of the above-mentioned first application software works with the audio parameter of the above-mentioned output audio parameter setting section, and

at exit of the above-mentioned first application software, the audio parameter set in the above-mentioned operating audio parameter setting section is stored in the above-mentioned exiting audio parameter storage section, the audio parameter set in the above-mentioned starting audio parameter storage section of the above-mentioned first application software is read out, and the audio parameter of the above-mentioned output audio parameter setting section on the above-mentioned operating system is returned to the audio parameter read out and is stored.

The object of the present invention has an effect of realizing an audio player, a method of managing an audio parameter of application software and program thereof that automatically register an appropriate value of the audio parameter set for each application software by the user without imposing the user on an extra registering operation.

The object of the present invention has an effect of realizing an audio player, a method of managing an audio parameter of application software and program thereof in which each of application software and operating system automatically operates at the appropriate audio parameter value without imposing a heavy burden of calculation on the application software.

The object of the present invention has an effect of realizing an audio player, a method of managing an audio parameter of application software and program thereof that automatically set the appropriate mute-on/off mode controlled by the user for each application software after each switching over to another application software.

The object of the present invention has an effect of realizing an audio player, a method of managing an audio parameter of application software and program thereof that set and manage the optimal audio parameter for audio playback of each of application software and operating system by starting audio parameter setting function a minimum number of times.

In the above-mentioned method of managing audio parameter of application software in accordance with the present invention from another aspect, the above-mentioned audio parameter further comprises audio volume left-right balance value.

In the above-mentioned program of the method of managing audio parameter of application software in accordance with the present invention from another aspect, the above-mentioned audio parameter further comprises audio volume left-right balance value.

In the above-mentioned audio player in accordance with the present invention from another aspect, the above-mentioned audio parameter further comprises audio volume left-right balance value.

The present invention can realize a method of managing audio parameter of application software, program thereof and an audio player that automatically set the appropriate left-right balance value for application or operating system when the user switches one or more application software and operating system.

In the above-mentioned method of managing audio parameter of application software in accordance with the present invention from another aspect, audio parameters of plural generations are stored as the above-mentioned exiting audio parameter and/or the above-mentioned starting audio parameter and the user selects one audio parameter at start and/or exit of the above-mentioned application software.

In the above-mentioned audio player in accordance with the present invention from another aspect, audio parameters of plural generations are stored in the above-mentioned exiting audio parameter storage section and/or the above-mentioned starting audio parameter storage section, and the user selects one audio parameter at start and/or exit of the above-mentioned first application software.

The present invention can realize a method of managing audio parameter of application software (and program thereof) and an audio player that present audio parameters for plural generations to the user and automatically set the appropriate audio parameter for application or operating system selected by the user when the user switches one or more application software and operating system. The audio parameters for plural generations mean the values of each audio parameter when the user uses and exits the application software plural times.

In the above-mentioned method of managing audio parameter of application software in accordance with the present invention from another aspect, at start of the above-mentioned application software, the above-mentioned audio data playback function is performed according to one audio parameter that the user selects from the above-mentioned exiting audio parameter and preset default audio parameter.

The present invention can realize a method of managing audio parameter of application software (and program thereof and an audio player) that automatically set the appropriate audio parameter selected by the user, at start of the application software.

In the above-mentioned method of managing audio parameter of application software in accordance with the present invention from another aspect, at exit of the above-mentioned application software, the above-mentioned audio data playback function is performed according to one audio parameter that the user selects from the above-mentioned starting audio parameter and preset default audio parameter.

The present invention can realize a method of managing audio parameter of application software (and program thereof and an audio player) that automatically set the appropriate audio parameter selected by the user and the operating system operates according to the audio parameter, at exit of the application software.

The above-mentioned audio player in accordance with the present invention from another aspect is an audio player with an operating system for installing programs of the above-mentioned first application software and a second application software as application software having neither the above-mentioned exiting audio parameter storage section nor the above-mentioned starting audio parameter storage section and selectively performing operations thereof, wherein

the above-mentioned installation section installs programs of the above-mentioned first and second application software, and

at start and during operation of the above-mentioned second application software, the audio parameter of the above-mentioned second application software works with the audio parameter of the above-mentioned output audio parameter setting section on the above-mentioned operating system, and at exit of the above-mentioned second application software, the audio parameter set in the above-mentioned operating audio parameter setting section is maintained.

The present invention can realize an audio player (and a method of managing audio parameter of application software and program thereof) that effect operation of various pieces of application software that operate differently smoothly.

In the above-mentioned program of a method of managing audio parameter of application software in accordance with the present invention from another aspect, a plurality of the above-mentioned user selectable default audio parameters are stored in the above-mentioned exiting audio parameter storage section and/or the above-mentioned starting audio parameter storage section.

In the above-mentioned audio player in accordance with the present invention from another aspect, the above-mentioned first application software stores plural audio parameters in the above-mentioned exiting audio parameter storage section and/or the above-mentioned starting audio parameter storage section, and the user selects one audio parameter at start and/or exit of the above-mentioned first application software.

The present invention can realize a program of a method of managing audio parameter of application software and an audio player that automatically set the appropriate audio parameter selected by the user and the operating system operates according to the audio parameter, at start or exit of the application software.

In the above-mentioned audio player in accordance with the present invention from another aspect, the above-mentioned plural first application software are installed and each of the above-mentioned first application software has its own the above-mentioned exiting audio parameter storage section.

In the above-mentioned audio player in accordance with the present invention from another aspect, each of the above-mentioned first application software has its own the above-mentioned starting audio parameter storage section.

The present invention can realize an audio player that stores the appropriate audio parameter for each application software.

The novel features of the invention are set forth with particularity in the appended claims. The invention as to both structure and content, and other objects and features thereof will best be understood from the detailed description when considered in connection with the accompanying drawings.

### BRIEF DESCRIPTION OF DRAWINGS

FIG. 1 is a block diagram showing a constitution-of a personal computer as an audio player in an embodiment according to the present invention.

FIG. 2 is a view showing relationship between the personal computer as the audio player and audio and music data in the embodiment according to the present invention.

FIG. 3 is a flowchart of a method of managing audio parameter of a first application software in the embodiment according to the present invention.

FIG. 4 is a view showing an example of audio parameter setting window in the embodiment according to the present invention.

FIG. 5 is a view showing an example of transition in audio volume value at the start and exit of application software in the embodiment according to the present invention.

FIG. 6 is other view showing an example of transition in audio volume value at start and exit of application software in another embodiment according to the present invention.

FIG. 7 is another view showing an example of transition in audio volume value at start and exit of application software in another embodiment according to the present invention.

FIG. 8 is a view showing an example of transition in mute-on/off information at start and exit of application software in the embodiment according to the present invention.

Part or all of the drawings are drawn schematically for diagrammatic representation and it should be considered that they do not necessarily reflect relative size and position of components shown therein.

### DETAILED DESCRIPTION OF THE INVENTION

Embodiments that specifically show the best mode for conducting the present invention will be described below with reference to figures.

<<Embodiment>>

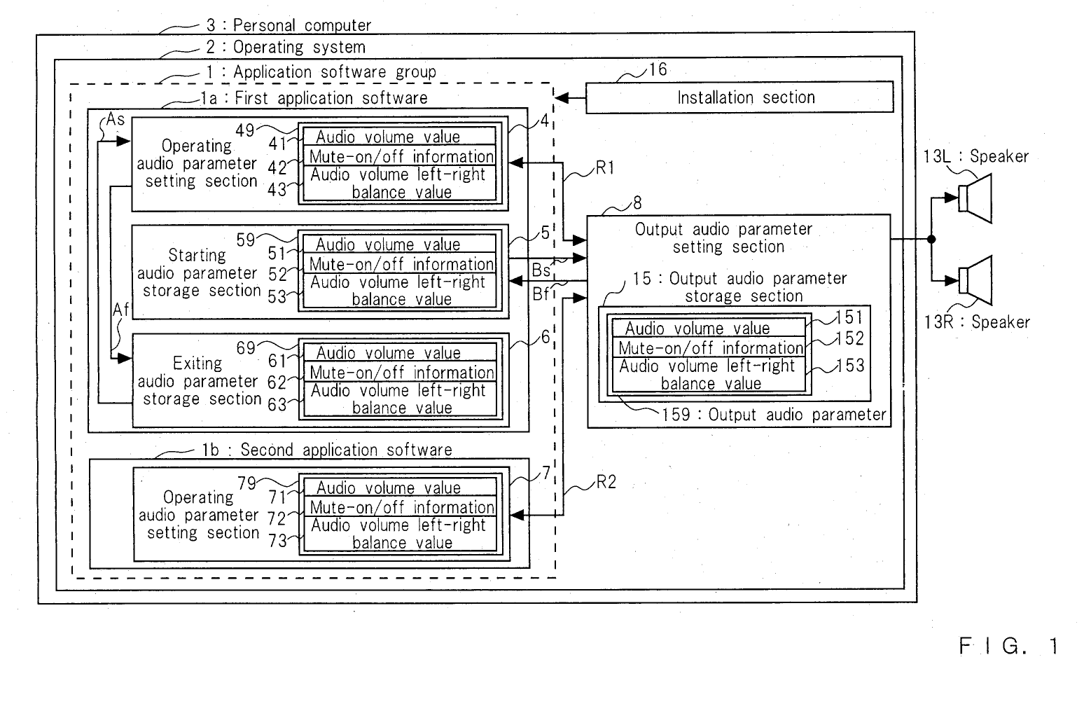

Referring to FIGS. 1 to 8, an audio player, a method of managing an audio parameter of application software and program thereof in an embodiment according to the present invention.

FIG. 1 is a block diagram showing the constitution of a personal computer (hereinafter referred to as “PC”) as the audio player in the embodiment according to the present invention. It shows, in particular, an audio parameter management part of the PC 3. The PC 3 has an operating system 2 and is connected to a left speaker 13L and a right speaker 13R. An installation section 16, an output audio parameter setting section 8, and an application software group 1 including a first application software 1a and a second application software 1b run on the operating system 2. In the case that there is no need to distinguish the first application software 1a from the second application software 1b, they are collectively referred to as “application software”.

The output audio parameter setting section 8 has an output audio parameter storage section 15. The output audio parameter storage section 15 stores an output audio parameter 159 as an audio parameter used in outputting audio data to the left and right speakers 13L and 13R. The output audio parameter 159 includes an audio volume value 151, mute-on/off information 152 and an audio volume left-right balance value 153. In this embodiment, the audio volume value 151 is any value of six levels from 0 to 5. The PC 3 outputs the audio data as a value obtained by multiplying an audio data by the audio volume value 151 of each level (for example, a value less than 1, or equal to 1 or more. At 0 level, the audio volume value 151 is 0, and the PC 3 outputs no audio data). For facilitation of explanation, the value of each level from 0 to 5 as it is, is hereinafter represented as the audio volume value 151.

The audio volume left-right balance value 153 represents audio volume balance between the left and right speakers 13=and 13R. In this embodiment, when the audio volume left-right balance value 153 is 1, audio volume value of the right speaker 13R is 0 (only the left speaker 13L outputs sound). In the case of the value 153 of 0.5, audio volume value of the left speaker is equal to that of right speaker, and in the case of the value 153 of 0, audio volume value of the left speaker 13L is 0 (only the right speaker 13R outputs sound). When the mute-on/off information 152 is “OFF”, the output audio parameter setting section 8 converts input audio data into audio data according to the audio volume value 151 stored in the output audio parameter storage section 15 and the audio volume left-right balance value 153, and transmits the converted audio data to a digital-analog converter (not shown). A speaker driving section (not shown) receives input of analog audio data outputted from the digital-analog converter and outputs sound to the left and right speakers 13L and 13R. When the mute-on/off information 152 is “ON” (quiet mode), mute function is performed so that the output audio parameter setting section 8 outputs no audio data.

The installation section 16 starts software for installing application software and installs the application software into PC 3. The application software is recorded on a recording medium readable in the PC 3 such as CD and the like or distributed on the internet. The installation section 16 starts the application software automatically or interactively with the user and installs it into the PC 3.

The first application software 1a and the second application software 1b each have an audio parameter managing function. Application software provided independently of each application software may monitor operations of each application software (for example, monitor data transferred between each application software and the operating system) or control each audio parameter managing function for the first application software 1a (for example, set an operating audio parameter setting section 4, a starting audio parameter storage section 5 and an exiting audio parameter storage section 6 in the first application software 1a, and an operating audio parameter setting section 7 in the second application software 1b).

The audio parameter is a parameter for controlling audio output from the speaker 13L and the speaker 13R including audio volume value, mute-on/off information and audio volume left-right balance value. The first application software 1a manages the audio parameter by the operating audio parameter setting section 4, the starting audio parameter storage section 5 and the exiting audio parameter storage section 6. The second application software 1b manages the audio parameter of output sound by the operating audio parameter setting section 7. In FIG. 1, R1, R2, As, Af, Bs and Bf represent the audio parameter.

The first application software 1a (or in the case that there are plural first application software 1a, each of the first application software 1a) is provided with the operating audio parameter setting section 4, the starting audio parameter storage section 5 and the exiting audio parameter storage section 6, and the second application software 1b is provided with the operating audio parameter setting section 7. In the operating audio parameter setting section 4, an operating audio parameter 49 (audio volume value 41, mute-on/off information 42 and audio volume left-right balance value 43) during operation of the first application software 1a is set. During operation of the first application software 1a, the operating audio parameter 49 works with the output audio parameter 159 on the operating system 2 (both are the same value) (audio parameter R1). The starting audio parameter storage section 5 stores the output audio parameter 159 stored in the output audio parameter storage section 15 on the operating system 2 at start of the first application software 1a, as a starting audio parameter 59 (audio volume value 51, mute-on/off information 52 and audio volume left-right balance value 53) (audio parameter Bf). At exit of the first application software 1a, the starting audio parameter 59 is transmitted to the output audio parameter storage section 15 (audio parameter Bs). The exiting audio parameter storage section 6 stores the audio parameter stored in the operating audio parameter setting section 4 at exit of the first application software 1a, as an exiting audio parameter 69 (audio volume value 61, mute-on/off information 62 and audio volume left-right balance value 63) (audio parameter Af). At start of the first application software 1a, the exiting audio parameter 69 is transmitted to the operating audio parameter setting section 4 (audio parameter As). The method of managing audio parameter in the first application software 1a will be later described in detail.

The second application software 1b (or in the case that there are plural second application software 1b, each of the second application software 1b) is provided with the operating audio parameter setting section 7. In the operating audio parameter setting section 7, an operating audio parameter 79 (audio volume value 71, mute-on/off information 72 and audio volume left-right balance value 73) is set. During operation of the second application software 1b, the operating audio parameter 79 works with the output audio parameter 159 (both are the same value) (audio parameter R2).

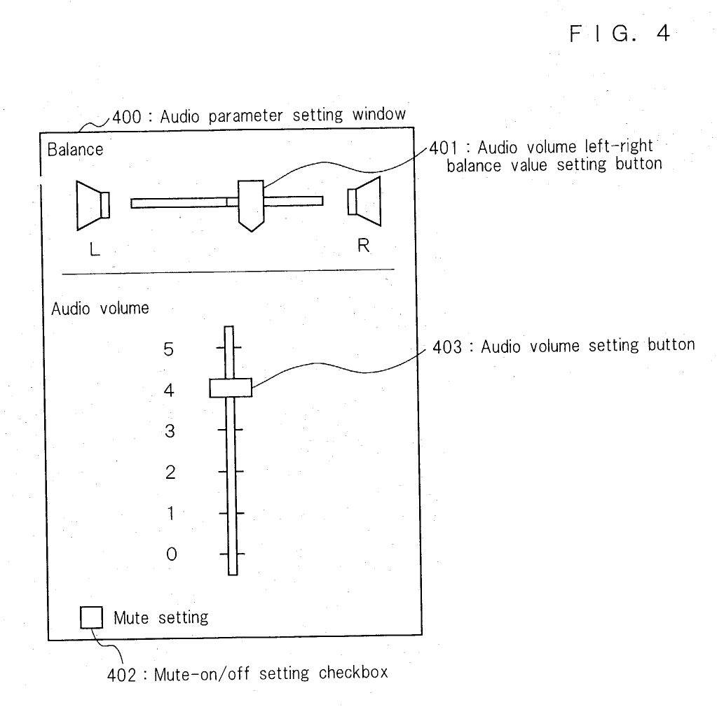

FIG. 4 is a view showing an example of an audio parameter setting window in the embodiment according to the present invention. In the case that the output audio parameter 159 is changed on the operating system 2 or during operation of the first application software 1a or the second application software 1b, an audio parameter setting window 400 is displayed on a monitor (not shown) connected to the PC 3. On the audio parameter setting window 400 an audio volume value setting button 403 for setting audio volume value, an audio volume left-right balance value setting button 401 for setting audio volume left-right balance value and a mute on/off setting checkbox 402 for setting whether or not mute on/off function is performed are drawn. The user can control the audio volume value setting button 403 and the audio volume left-right balance value setting button 401 by using mouse or keyboard. The sound of audio parameter in accordance with the displayed position of each button is output from the speakers 13L and 13R. When the user marks the mute on/off setting checkbox 402, no sound is output.

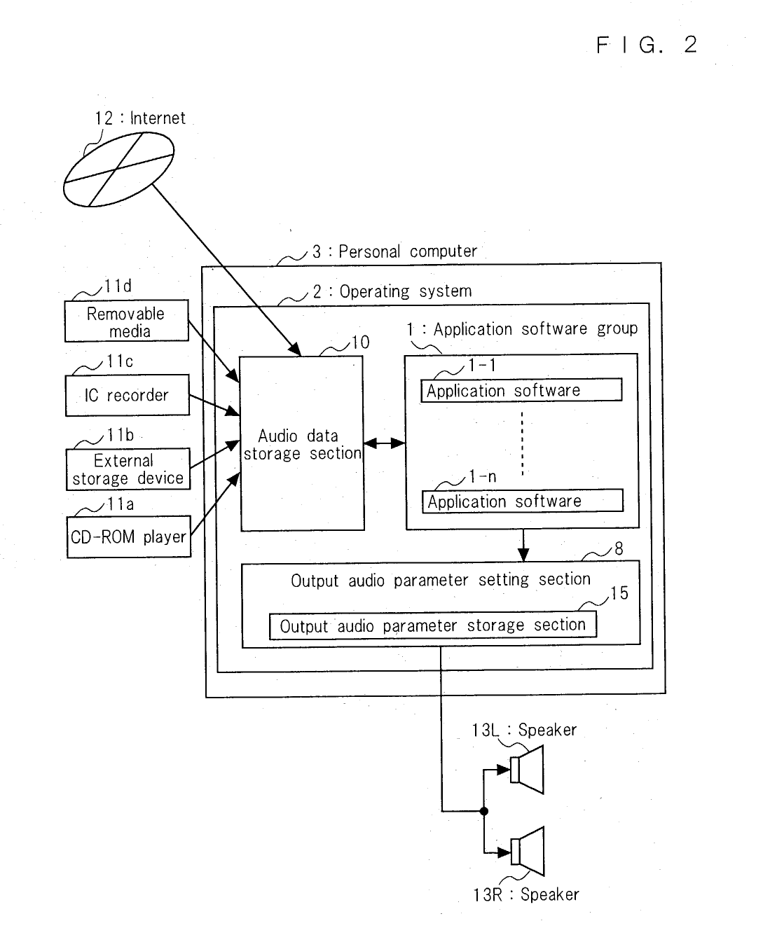

FIG. 2 is a view showing relationship between the PC 3 as the audio player and sound and music data in the embodiment according to the present invention. The operating system 2 of the PC 3 has an audio data storage section 10 such as hard disk. An application software group 1 includes application software 1-1 to application software 1-n, each of which has an audio parameter managing function. These application software correspond to either the first application software 1a having the operating audio parameter setting section 4, the starting audio parameter storage section 5 and the exiting audio parameter storage section 6 or the second application software 1b having the operating audio parameter setting section 7 and no starting audio parameter storage section 5. The application software group 1 comprises at least one first application software 1a.

Data of movie file, music file, game program and so on, including audio data is stored in the audio data storage section 10 from a storage device such as a CD-ROM player 11a, an external storage device 11b, an IC recorder 11c, a removable media lid or the internet 12 via various interfaces. The user properly selects the application software corresponding to the storage device or audio data format from the application software group 1 and starts it to play audio data stored in the audio data storage section 10. As mentioned above, the user can change the audio parameter for outputting sound.

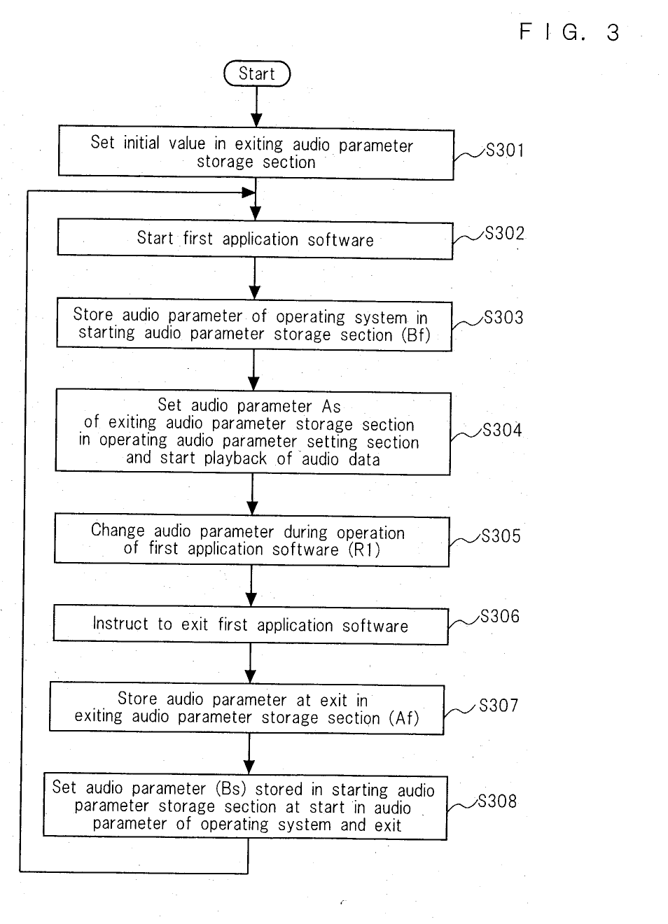

Next, the method of managing the audio parameter of the first application software will be described with reference to the flowchart of FIG. 3 and FIG. 1.

Firstly, the operating system 2 set an initial value of the audio parameter in the exiting audio parameter storage section 6 (S301). The initial value of the audio parameter is a value prescribed in the first application software 1a. At a step S302, the first application software 1a is started. At a step S303, the output audio parameter 159 on the operating system 2 is stored in the starting audio parameter storage section 5 as the starting audio parameter 59 (audio parameter Bf). At a step S304, the exiting audio parameter 69 stored in the exiting audio parameter storage section 6 is set in the operating audio parameter setting section 4 as the operating audio parameter 49 (audio parameter As). Audio data is played.

During operation of the first application software 1a (S305), the user can change the operating audio parameter 49 if necessary. The user can change any audio parameter among the audio volume value 41, the mute on/off information 42 and the audio volume left-right balance value 43. The operating audio parameter 49 works with the output audio parameter 159 (audio parameter R1).

At a step S306, an instruction to exit the first application software 1a is issued. At a step S307, the operating audio parameter 49 set in the operating audio parameter setting section 4 is stored in the exiting audio parameter storage section 6 (audio parameter Af). At a step S308, the output audio parameter 159 on the operating system 2 is replaced with the starting audio parameter 59 (audio parameter Bs). Operation of the first application software is exited. Whatever the operating audio parameter 49 set during operation of the first application software 1a may be, audio data is played according to the audio parameter with the same value as the starting audio parameter 59 before start of the first application software 1a.

When the first application software 1a is started again, operation returns to the step S302. Whatever the value of the output audio parameter 159 before start of the first application software 1a may be, audio data is played according to the audio parameter with the same value as the exiting audio parameter 69 at exit of the first application software 1a.

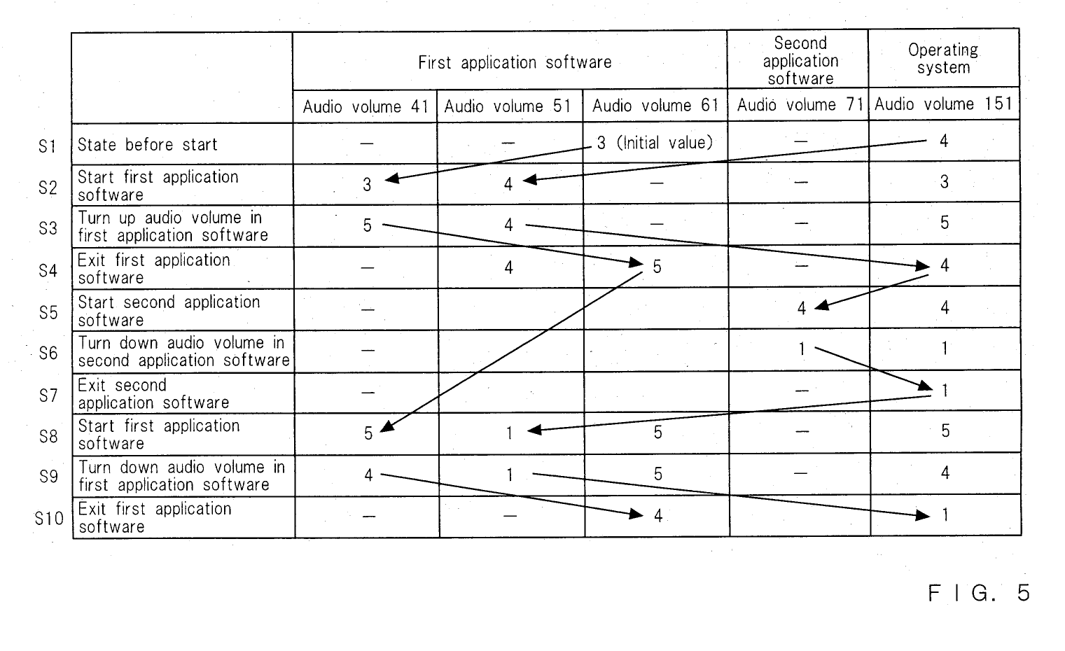

Next, FIGS. 5 to 8 show examples of transition in audio parameter at start and exit of application software.

FIG. 5 is a view showing an example of transition in audio volume value at the start and exit of application software.

A state S1 is a state before start of the first application software 1a. The audio volume value 61 of the exiting audio parameter storage section 6 is “the initial value 3”. In this embodiment, the initial value of the audio volume value is set to be medium value of a possible range of values (0 to 5). Provided that the output audio parameter storage section 15 on the operating system 2 stores the audio volume value 151 of “4” therein.

In a state S2, the first application software 1a is started. The operating audio parameter setting section 4 obtains the audio volume value 61 of “3” stored in the exiting audio parameter storage section 6 and audio data is played. At the same time, the starting audio parameter storage section 5 stores the audio volume 151 of “4” on the operating system 2 in the state S1 therein. In a state S3, during operation of the first application software 1a, the audio volume value 41 is turned up to “5”. In a state S4, the first application software 1a is exited. The audio volume value 151 on the operating system 2 becomes the audio volume value 51 of “4” stored in the starting audio parameter storage section 5 in the state S2. The audio volume value 41 of “5” in the operating audio parameter setting section 4 at exit of the first application software 1a is stored in the exiting/audio parameter storage section 6.

In a state S5, the second application software 1b is started. The second application software 1b has neither starting audio parameter storage section nor exiting audio parameter storage section. Therefore, the audio volume value 71 in the state S5 becomes the audio volume value 151 of “4” of the output audio parameter on the operating system 2. In a state S6, during operation of the second application software 1b, the audio volume value 71 is turned down to “1”. In a state S7, when the second application software 1b is exited, the audio volume value 151 on the operating system 2 is kept to be “1” as it is.

In a state S8, the first application software 1a is started again. Audio data is played according to the audio volume value 61 of “5” stored in the exiting audio parameter storage section 6 in the state S4 (that is, when the first application software 1a is exited last time). At the same time, the starting audio parameter storage section 5 stores the audio volume value 151 of “1” on the operating system 2 in the state S7 therein.

In a state S9, during operation of the first application software 1a, the audio volume value 41 is turned down to “4”. In a state S10, the first application software 1a is exited. The audio volume value 151 on the operating system 2 becomes the audio volume value 51 of “1” stored in the starting audio parameter storage section 5 in the state S8. The audio volume value 41 of “4” in the operating audio parameter setting section 4 at exit of the first application software 1a is stored in the exiting audio parameter storage section 6.

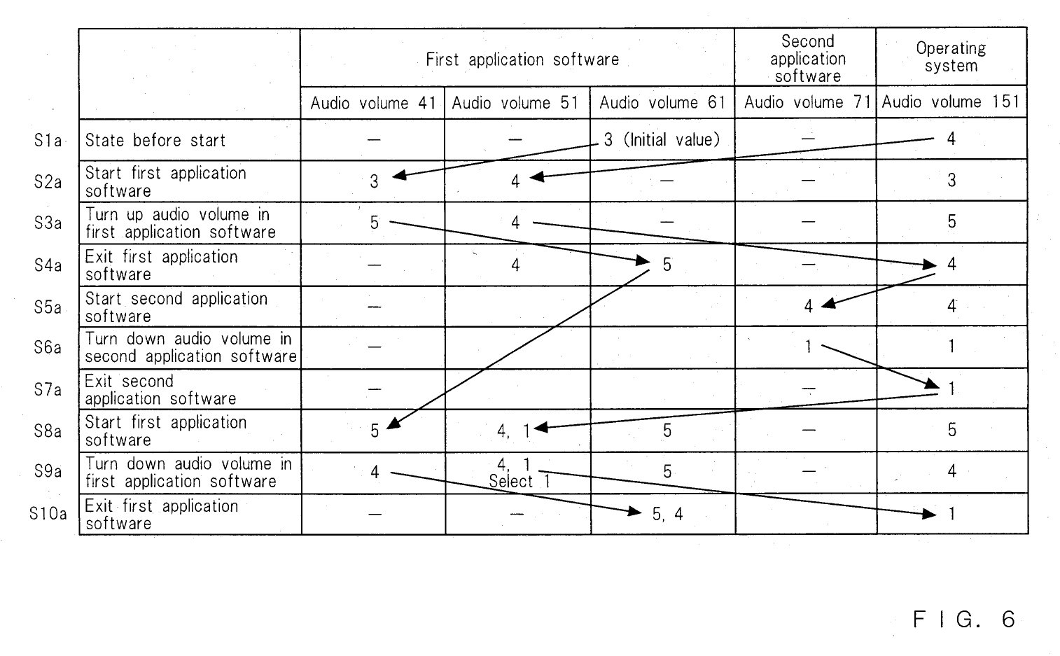

An audio player, a method of managing an audio parameter of application software of application software and operations of program thereof in a partially modified embodiment will be described. FIG. 6 is other view showing an example of transition in audio volume value at start and exit of application software in the audio player and the method of managing the audio parameter of application software. FIG. 6 shows transition in audio volume value in states S1a to S10a corresponding to the states S1 to S10 in FIG. 5. In the audio player and the method of managing the audio parameter of application software, the exiting audio parameter storage section 6 and the starting audio parameter storage section 5 are constituted so as to store the current audio volume value as well as the audio volume value of each generation in the case that the first application software 1a is started and exited plural times. The operations in FIG. 6 which are different to those in FIG. 5 will be described below.

In a state S8a, the audio volume value 151 of “1” in a state S7a is added to the audio volume value 51 of “4” stored in a state S2a and stored in the starting audio parameter storage section 5. That is, the audio volume values for two generations are stored. In a state S9a, during operation of the first application software 1a, the audio volume value 41 is turned down to “4”. In a state S10a, the first application software 1a is exited. At this time, the first application software 1a displays a request that the user selects either the audio volume value stored in the starting audio parameter storage section 5 of “1” or “4” as the audio volume value 151 on the operating system 2 on the screen. The user selects either the audio volume value stored in the starting audio parameter storage section 5 of “1” or “4” (“1” in FIG. 6) as the audio volume value 151 on the operating system 2.

The audio volume value 41 of “4” in the operating audio parameter setting section 4 at exit of the first application software 1a is stored in the exiting audio parameter storage section 6. At this time, the audio volume value 61 of “5” stored in the exiting audio parameter storage section 6 in a state S4a is also stored. When the first application software 1a is started again, the first application software 1a displays a request that the user selects either the audio volume value stored in the exiting audio parameter storage section 6 of “5” or “4” as the audio volume value 151 on the operating system 2 on the screen. The user selects either the audio volume value stored in the exiting audio parameter storage section 6 of “5” or “4” as the audio volume value 151 on the operating system 2.

In the example as shown in FIG. 6, plural audio volume values are stored in the starting audio parameter section 5 and the exiting audio parameter section 6 so that the user can select-one among these values. It means that the user can select a desirable audio volume value among the pre-selected audio volume values. It is more practicable for the user to set the upper limit of the number of stored audio volume values beforehand so that the number of audio volume values stored in the starting audio parameter section and the exiting audio parameter section 6 may not increase after each start and exit of the first application software 1a. For example, the latest three audio volume values may be stored.

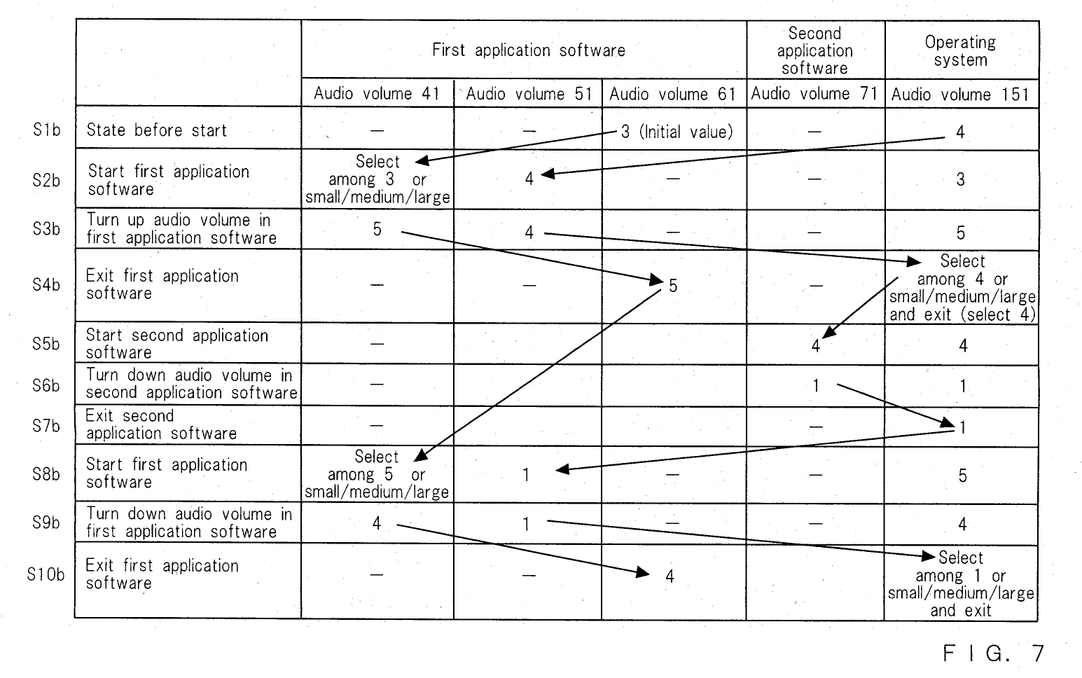

An audio player, a method of managing an audio parameter of application software and operations of program thereof in another partially modified embodiment will be described. FIG. 7 is another view showing an example of transition in audio volume value at start and exit of application software in the audio player and the method of managing the audio parameter of application software. FIG. 7 shows transition in audio volume value in states S1b to S10b corresponding to the states S1 to S10 in FIG. 5. However, it is constituted so that plural default audio volume values are preset as audio volume value of output sound in the first application software 1a. When the first application software 1a is started, the user can select one audio volume value among the audio volume value 61 stored in the exiting audio parameter storage section 6 and the default audio volume values. And the first application software 1a is exited, the user can select one audio volume value as the audio volume value on the operating system 2 among the audio volume value 51 stored in the starting audio parameter storage section 5 and the default audio volume values. The operations in FIG. 7 which are different to those in FIG. 5 will be described below.

In FIG. 7, three values: “large (audio volume value of 5)”, “medium (audio volume value of 3) and “small (audio volume value of 1) are set as the default audio volume values. In a state S2b, when the first application software 1a is started, the first application software 1a displays a request that the user selects one value among the audio volume value 61 of “3” stored in the exiting audio parameter storage section 6 and the default audio volume values (large, medium and small) as the audio volume value 151 on the operating system 2 on the screen. The user selects the audio volume value of “3” stored in the exiting audio parameter storage section 6 as the audio volume value 151 on the operating system 2.

In a state S4b, when the first application software 1a is exited, the first application software 1a displays a request that the user selects one value among the audio volume value 51 of “4” stored in the starting audio parameter storage section 5 and the default audio volume values (large, medium and small) as the audio volume value 151 on the operating system 2 on the screen. The user selects the audio volume value of “4” stored in the starting audio parameter storage section 5 as the audio volume value 151 on the operating system 2.

In a state S8b, when the first application software 1a is started again, according to the similar procedure, the user selects the audio volume value of “5” among the audio volume value 61 of “5” stored in the exiting audio parameter storage section 6 and the default audio volume values (large, medium and small). In a state S10b, when the first application software 1a is exited, according to the similar procedure, the user selects the audio volume value of “1” among the audio volume value 51 of “1” stored in the starting audio parameter storage section 5 and the default audio volume values (large, medium and small).

In the example as shown in FIG. 7, the user can check the preset audio volume value and the default audio volume values and select one audio volume value among them at start and exit of the first application software 1a.

By starting and exiting the application software, the audio volume left-right balance value transits as in the case of audio volume value (FIGS. 5 to 7).

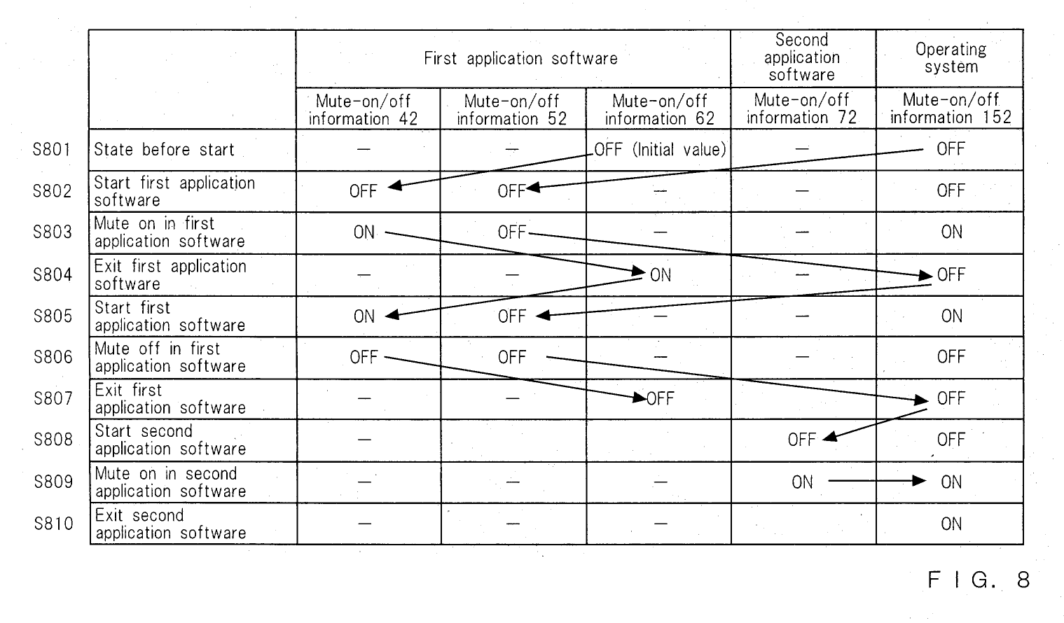

FIG. 8 is a view showing an example of transition in mute-on/off information at start and exit of application software in the embodiment according to the present invention.

A state S801 is a state before start of the first application software 1a. The exiting audio parameter storage section 6 stores an initial value of the mute-on/off information 62 as “OFF”. Provided that the mute-on/off information 152 on the operating system 2 is “OFF”.

In a state S802, the first application software 1a is started. The operating audio parameter setting section 4 obtains the mute-on/off information 62 of “OFF” stored in the exiting audio parameter storage section 6 and audio data is played. At the same time, the starting audio parameter storage section 5 stores the mute-on/off information 152 of “OFF” on the operating system 2 in the state S801 therein. In a state S803, output sound from the first application software 1a is muted (mute-on). In a state S804, the first application software 1a is exited. The mute-on/off information 152 on the operating system 2 becomes the mute-on/off information 52 of “OFF” stored in the starting audio parameter storage section 5 in the S802. Therefore, sound is output to the speakers 13L and 13R. The mute-on/off information 42 of “ON” stored in the operating audio parameter setting section 4 is stored in the exiting audio parameter storage section 6.

In a state S805, the first application software 1a is started again. The operating audio parameter setting section 4 obtains the mute-on/off information 62 of “ON” stored in the exiting audio parameter storage section 6. Therefore, no sound is output to the speakers 13L and 13R. At the same time, the starting audio parameter storage section 5 stores the mute-on/off information 152 of “OFF” on the operating system 2 in the state S804 therein.

In a state S806, during operation of the first application software 1a, mute function is turned off (mute-off). In a state S807, the first application software 1a is exited. The mute-on/off information 152 on the operating system 2 remains to be the mute-on/off information 52 of “OFF” stored in the starting audio parameter storage section 5. The mute-on/off information 42 of “OFF” in the operating audio parameter setting section 4 is stored in the exiting audio parameter storage section 6.

In a state S808, the second application software 1b is started. The second application software 1b has neither starting audio parameter storage section nor exiting audio parameter storage section. Therefore, the mute-on/off information 72 in the state S808 becomes the mute-on/off information 152 of “OFF” on the operating system 2 in the state S807. In a state S809, output sound of the second application software 1b is muted. In a state S810, the second application software 1b is exited. The mute-on/off information 152 on the operating system 2 remains to be “ON”.

In the example as shown in FIG. 8, the user can set mute-on state (quiet mode) on the operating system as well as set mute-off state (sound mode) only during operation of certain application software.

Moreover, at start of the first application software 1a, the user may select one among the mute-on/off information 62 stored in the exiting audio parameter storage section 6 and the preset default mute-on/off information, and start the mute-on/off function according to the selected mute-on/off information.

At exit of the first application software 1a, the user may select one among the mute-on/off information 62 stored in the starting audio parameter storage section 5 and the preset default mute-on/off information, and start the mute-on/off function according to the selected mute-on/off information.

FIGS. 5 to 8 show examples of transition in audio parameter of audio volume value or mute-on/off information. It may be constituted so that two or more of three audio parameters of audio volume value, mute-on/off information and audio volume left-right balance value transit. Further, it may be constituted so as to have a cooperative function of each audio parameter in which minimum audio volume value (0 in the above-mentioned embodiment) and maximum audio volume value (5 in the above-mentioned embodiment) are treated equally to mute-on and mute-off, respectively.

Although one first application software 1a and one second application software 1b are installed in the PC 3 in the embodiment, a plurality of the first application software 1a may be installed in the PC3. It is possible that a plurality of the first application software 1a is started concurrently. Each first application software 1a has the starting audio parameter storage section 5 separately or commonly.

A program for performing the above-mentioned method is read into PC, audio apparatus, home audiovisual system apparatus, an audio player by using network, etc. and put into execution, thereby these devices can serve as an audio player.

According to the present invention, it is possible to obtain the advantageous effect of realizing the audio player, the method of managing audio parameter of application software and program thereof that automatically register an appropriate value of the audio parameter set for each application software without imposing the user on an extra registering operation of audio parameter.

According to the present invention, it is possible to obtain the advantageous effect of realizing the audio player, the method of managing audio parameter of application software and program thereof in which each of application software and operating system automatically operates at the appropriate audio parameter value without imposing a heavy burden of calculation on the application software.

According to the present invention, it is possible to obtain the advantageous effect of realizing the audio player, the method of managing audio parameter of application software and program thereof that automatically set the appropriate mute-on/off mode for each application software after each switching over to another application software.

According to the present invention, it is possible to obtain the advantageous effect of realizing the audio player, the method of managing audio parameter of application software and program thereof that set and manage the optimal audio parameter for audio playback of each of application software and operating system by starting audio parameter setting function a minimum number of times.

Clearly, numerous modifications and variations of the instant invention are possible in light of the above teachings. It is therefore understood that, within the scope and spirit of the claims made herein, the invention may be practiced otherwise than as specifically described herein, the invention may be modified in arrangement and detail without departing from such scope and spirit and, further, the utility described herein is by way of example.

1. A method of managing audio parameter of application software for audio record and/or playback with an audio parameter managing function or application software that has an audio parameter managing function and manages audio data files, said application software being used on an operating system, wherein
audio parameter comprises at least one parameter of audio volume value and mute-on/off information,
at start of said application software, a starting audio parameter set in said operating system is stored, and whatever-said starting audio parameter may be, audio data playback function is performed according to an exiting audio parameter when said application software was exited: last time,
at exit of said application software, audio parameter at this time is stored as said exiting audio parameter of said application software, setting is switched from said exiting audio parameter to said starting audio parameter set on said operating system before start of said application software, and audio data playback function is performed according to said starting audio parameter.

2. A method of managing audio parameter of application software in accordance with claim 1, wherein said audio parameter further comprises audio volume left-right balance value.

3. A method of managing audio parameter of application software in accordance with claim 1, wherein audio parameters of plural generations are stored as said exiting audio parameter and/or said starting audio parameter and the user selects one audio parameter at start and/or exit of said application software.

4. A method of managing audio parameter of application software in accordance with claim 1, wherein at start of said application software, said audio data playback function is performed according to one audio parameter that the user selects from said exiting audio parameter and preset default audio parameter.

5. A method of managing audio parameter of application software in accordance with claim 1, wherein at exit of said application software, said audio data playback function is performed according to one audio parameter that the user selects from said starting audio parameter and preset default audio parameter.

6. A program of a method of managing audio parameter of application software for audio record and/or playback with an audio parameter managing function or application software that has an audio parameter managing function and manages audio data files, wherein
said audio parameter comprises at least one parameter of audio volume value and mute-on/off information, and
said program makes a device that operates on an operating system comprise:
an operating audio parameter setting section that sets an operating audio parameter working with an audio parameter set on said operating system in response to the user's switch of setting of audio parameter during operation of said application software,
a starting audio parameter storage-section that stores the audio parameter set on said operating system at start of said application software therein, and
an exiting audio parameter storage section that stores said operating audio parameter at that time of said application software at exit of said application software therein.

7. A program of a method of managing audio parameter of application software in accordance with claim 6, wherein said audio parameter further comprises an audio volume left-right balance value.

8. A program of a method of managing audio parameter of application software in accordance with claim 6, wherein a plurality of said user selectable default audio parameters are stored in said exiting audio parameter storage section and/or said starting audio parameter storage section.

9. An audio player with an operating system for installing program of a first application software as application software stated in claim 6 and performing operations thereof, wherein
said operating system comprises an installation section for installing program of said first application software, and a output audio parameter setting section for setting audio parameter of audio playback output in response to change in audio parameter,
at start of said first application software, audio parameter set in said output audio parameter setting section is stored in said starting audio parameter storage section of said first application software, the audio parameter stored in said exiting audio parameter storage section of said first application software is read out, and the value is set in said operating audio parameter setting section,
during operation of said first application software, sound is played while the audio parameter stored in said operating audio parameter setting section of said first application software works with the audio parameter of said output audio parameter setting section, and
at exit of said first application software, the audio parameter set in said operating audio parameter setting section is stored in said exiting audio parameter storage section, the audio parameter set in said starting audio parameter storage section of said first application software is read out, and the audio parameter of said output audio parameter setting section on said operating system is returned to the audio parameter read out and is stored.

10. An audio player in accordance with claim 9, wherein said audio parameter further comprises an audio volume left-right valance value.

11. An audio player in accordance with claim 9, wherein audio parameters of plural generations are stored in said exiting audio parameter storage section and/or said starting audio parameter storage section, and the user selects one audio parameter at start and/or exit of said first application software.

12. An audio player in accordance with claim 9 with an operating system for installing programs of said first application software and a second application software as application software having neither said exiting audio parameter storage section nor said starting audio parameter storage section and selectively performing operations thereof, wherein
said installation section installs programs of said first and second application software, and
at start and during operation of said second application software, the audio parameter of said second application software works with the audio parameter of said output audio parameter setting section on said operating system, and at exit of said second application software, the audio parameter set in said operating audio parameter setting section is maintained.

13. An audio player in accordance with claim 9, wherein said first application software stores plural audio parameters in said exiting audio parameter storage section and/or said starting audio parameter storage section, and the user selects one audio parameter at start and/or exit of said first application software.

14. An audio player in accordance with claim 9, wherein plural said first application software are installed and each of said first application software has its own said exiting audio parameter storage section.

15. An audio player in accordance with claim 14, wherein each of said first application software has its own said starting audio parameter storage section.
